(19) United States
(12) Patent Application Publication
(10) Pub. No.: US 2006/0292309 A1
(43) Pub. Date: Dec. 28, 2006

(54) Method for clarification of wood having been treated with chemical containing copper, chromium or arsenic

(75) Inventors: Tomo Kakitani, Uji-shi (JP); Hata Toshimitsu, Uji-shi (JP); Imamura Yuji, Uji-shi (JP)

Correspondence Address: FITCH, EVEN, TABIN & FLANNERY, P. O. BOX 18415, WASHINGTON, DC, 20036, US

(73) Assignee: Kansai Technology Licensing Organization Co., Ltd., Kyoto-shi, Kyoto (JP)

(21) Appl. No.: 10/557,795

(22) PCT Filed: Jan. 29, 2004
(86) PCT No.: PCT/JP04/00846

§ 371 Date: Nov. 18, 2005

(30) Foreign Application Priority Data
May 20, 2003 (JP) 2003141961

(51) Int. Cl. B05D 1/18

(52) U.S. Cl. 427/440

(57) ABSTRACT

The invention provides a method for easily and efficiently extracting chemical components from wood treated with a chemical containing copper, and thereby detoxifying the wood. More specifically, the present invention relates to a method for detoxifying wood comprising immersing, in an aqueous solution of at least one alkali metal carboxylate selected from the group consisting of alkali metal monocarboxylates and alkali metal dicarboxylates, wood treated with a chemical containing copper, to extract the chemical component from the treated wood.

### TECHNICAL FIELD

The present invention relates to a method for detoxifying wood. More specifically, the present invention relates to a method for easily and efficiently removing harmful components from wood treated with a copper-containing chemical.

### BACKGROUND ART

Today most of the wood materials used for houses, utility poles, crossties, ground sills and like structural materials are treated with preservatives to enhance its durability. Representative wood preservatives are CCA (chromated copper arsenate compound-based wood preservative), CFKZ (chromated copper zinc compound-based wood preservative), ACQ (Ammoniacal copper quaternary compound-based wood preservative), CUAZ (copper boron alkylammonium compound-based wood preservative) and like waterborne wood preservatives, which all contain substances hazardous to humans such as copper and the like.

In recent years, the amounts of wood whose service life expired have been increasing worldwide, and the disposal of such treated wood has become a major concern.

When preservative-treated wood is simply burned or discarded in landfills, the hazardous substances contained in such wood may be released eventually into the environment. For this reason, detoxification of preservative-treated wood before disposal is required to prevent the hazardous substances in the treated wood from escaping into the environment.

Techniques for removing hazardous substances from preservative-treated wood reported include an extraction method using a supercritical solvent gas, and a wet extraction method using sulfuric acid and like strong acids (e.g. Unexamined Japanese Patent Publication No. H11-135563).

However, the former method suffers drawbacks; it requires a specially designed treatment equipment and control of the treatment process is complicated. Further, it is not feasible from an economic viewpoint.

Unlike the former technique, the latter method has the advantages of offering easy operation and not needing any special treatment equipment. However, it is disadvantageous because wood recovery is difficult due to the excessive decomposition of wood components by strong acid and extraction of the hazardous substances from the treated wood is insufficient. Especially, copper and chromium used as preservative components in wood are difficult to extract, and the wet extraction technique has not yet established for efficiently removing these from treated wood.

A recently reported method uses oxalic acid as an extractant to detoxify preservative-treated wood. However, this method has the problem of being incapable of thoroughly removing copper even if some other hazardous substances are removed from the treated wood (Kazi K. M. F., Cooper P. A., “Solvent Extraction of CCA-C from Out-of-Service Wood”, International Research Group on Wood Preservation, Document No.: IRG/WP-98-50107, Maastricht, The Netherlands, IRG Secretariat (Sweden), 1988, p 1-13).

In view of the defects in the known techniques, it is desired to develop a new method for extracting harmful substances, especially copper, easily and efficiently from wood treated with chemicals containing copper and chromium, and detoxifying such wood by the removal of these substances.

### DISCLOSURE OF THE INVENTION

An object of the present invention is to solve the above problems in the prior art, and to provide a method for detoxifying chemically treated wood. More specifically, an object of the present invention is to provide a method for easily and efficiently extracting chemical components from wood treated with a copper-containing chemical, thereby detoxifying the wood.

After painstaking research to achieve the above object, the inventors found that when the wood treated with a copper-containing chemical is subjected to extraction treatment for a chemical component using an aqueous solution of an alkali metal monocarboxylate and/or alkali metal dicarboxylate as an extractant, chemical components containing copper are easily and efficiently removed from the treated wood, whereby the wood is detoxified. The present invention has been accomplished by further research based on this finding.

The present invention provides the items described below:

Item 1. A method for detoxifying wood comprising immersing, in an aqueous solution of at least one alkali metal carboxylate selected from the group consisting of alkali metal monocarboxylates and alkali metal dicarboxylates, wood treated with a copper-containing chemical, to extract the chemical component from the treated wood.

Item 2. A method for detoxifying wood according to Item 1, wherein the copper-containing chemical further contains at least one component selected from the group consisting of arsenic and chromium.

Item 3. A method for detoxifying wood according to Item 1, wherein the wood treated with a copper-containing chemical has been treated with at least one water-soluble wood preservative selected from the group consisting of CCA, CFKZ, ACQ and CUAZ.

Item 4. A method for detoxifying wood according to Item 1, wherein the carboxylic acid for forming the alkali metal carboxylate is at least one acid selected from the group consisting of formic acid, acetic acid, propionic acid, butyric acid, isobutyric acid, glycolic acid, lactic acid, glyceric acid, oxalic acid, moronic acid, succinic acid, glutaric acid and adipic acid.

Item 5. A method for detoxifying wood according to Item 1, wherein the aqueous alkali metal carboxylate solution has an alkali metal carboxylate concentration of 0.01 to 2 mol/L.

Item 6. A method for detoxifying wood according to Item 1, wherein the aqueous alkali metal carboxylate solution has a pH of 0.1 to 5.

Item 7. A method for detoxifying wood according to Item 1, wherein the aqueous alkali metal carboxylate solution is an aqueous alkali metal dicarboxylate solution.

Item 8. A method for detoxifying wood according to Item 1, wherein the aqueous alkali metal carboxylate solution is an aqueous alkali metal oxalate solution.

Item 9. A method for detoxifying wood according to Item 1, wherein the aqueous alkali metal carboxylate solution is an aqueous sodium oxalate solution.

Item 10. A method for detoxifying wood according to Item 1, wherein the wood is immersed in an aqueous alkali metal carboxylate solution at a temperature of 30 to 90° C.

### BREIF DESCRIPTION OF DRAWINGS

FIG. 1 shows the residual percentages of copper, chromium and arsenic in wood (calculated based on the level of each metal element in wood before the extraction treatment being considered as 100%) 1 to 6 hours after detoxification of CCA-treated wood (Example 1) was initiated, using an aqueous sodium oxalate solution (pH 3.2).

FIG. 2 shows the residual percentage of copper in wood (based on the copper level in wood before the extraction treatment being considered as 100%) 1 to 6 hours after detoxification of ACQ-treated wood (Example 2) was initiated, using an aqueous sodium oxalate solution (pH 3.2).

FIG. 3 shows the residual percentage of copper in wood (calculated based on the copper level in wood before the extraction treatment being considered as 100%) 1 to 6 hours after detoxification of CUAZ-treated wood (Example 3) was initiated, using an aqueous sodium oxalate solution (pH 3.2).

FIG. 4 shows the residual percentages of copper, chromium and arsenic in wood (calculated based on the level of each metal element in wood before the extraction treatment being considered as 100%) 1 to 6 hours after detoxification of a mixed mass of CCA-treated wood, ACQ-treated wood and CUAZ-treated wood (Example 4) were initiated, using an aqueous sodium oxalate solution (pH 3.2).

### BEST MODE FOR CARRYING OUT THE INVENTION

The method for detoxifying wood of the present invention comprising immersing, in an aqueous solution of at least one alkali metal carboxylate selected from the group consisting of alkali metal monocarboxylates and alkali metal dicarboxylates, wood treated with a copper-containing chemical, to extract the chemical component from the wood. “Detoxification of wood” in the invention means the removal of copper and other harmful substances from wood.

Wood materials to be cleaned according to the invention are those treated with a chemical containing copper. The copper-containing chemicals referred to herein are any of those used to treat wood materials, and are not limited so long as copper is contained as a component. Specific examples of such chemicals are CCA (chromated copper arsenate compound-based wood preservative), CFKZ (chromated copper zinc compound-based wood preservative), ACQ (copper alkylammonium compound-based wood preservative), CUAZ (copper azole-based wood preservative) and like water-soluble wood preservatives. Woods to be detoxified by the method of the invention may be those treated with one of the above water-soluble wood preservatives or those treated with any combination of two or more of such water-soluble wood preservatives.

Considering that the invention is capable of removing chromium and arsenic efficiently in addition to copper, CCA- or CFKZ-treated wood is advantageously detoxified, and CCA-treated wood is especially advantageously detoxified in the invention.

Any wood materials treated with a copper-containing chemical can be detoxified by the method of the invention, and the copper concentration in wood is not restricted. Examples of wood materials to be detoxified in the invention are those containing copper content of 0.05 ppm or more, preferably 0.1 ppm or more, more preferably 0.5 ppm or more, and particularly preferably 1 ppm or more. The upper limit of the copper content in the wood to be detoxified in the invention is not limited, but 10000 ppm, and preferably 5000 ppm, can be given as examples.

The aqueous alkali metal carboxylate solution used in the invention (hereinafter referred to as an “extractant”) is an aqueous solution of at least one alkali metal carboxylate selected from the group consisting of alkali metal monocarboxylates and alkali metal dicarboxylates.

Carboxylic acids for forming alkali metal carboxylates used in such extractants are not restricted, and examples are monocarboxylic acids such as formic acid, acetic acid, propionic acid, butyric acid, isobutyric acid, glycolic acid, lactic acid, glyceric acid, etc., and dicarboxylic acids such as oxalic acid, moronic acid, succinic acid, glutaric acid, adipic acid, etc.

The alkali metals for forming alkali metal carboxylates used in extractants are not limited, and examples are lithium, sodium, potassium and the like.

In view of the higher inventive effects, the extractants preferably used in the invention are aqueous solutions of alkali metal dicarboxylates. Especially preferable are aqueous solutions of alkali metal oxalates, and particularly preferable is an aqueous solution of sodium oxalate. Aqueous solutions of alkali metal dicarboxylates encompass aqueous solutions of alkali metal dicarboxylates, alkali metal hydrogendicarboxylates, and mixtures thereof. For examples, aqueous solutions of sodium oxalate encompass aqueous solutions of sodium oxalate, sodium hydrogenoxalate, and mixtures thereof.

Extractants may be those containing a single alkali metal carboxylate, or two or more alkali metal carboxylates in combination. When two or more alkali metal carboxylates are used in combination, the combination mode is not limited, and may be any combination of two or more alkali metal monocarboxylates, two or more alkali metal dicarboxylates, or at least one alkali metal monocarboxylate with at least one alkali metal dicarboxylate.

A concentration of alkali metal carboxylate in the extractant varies in accordance with the type of alkali metal carboxylate used, and therefore cannot be specified. However, examples of alkali metal carboxylate concentration in an extractant are within the ranges of from 0.01 to 2 mol/L, preferably 0.05 to 1 mol/L, and more preferably 0.1 to 0.5 mol/L.

The pH values of such extractants are not limited, provided that the effects of the invention are not adversely affected. Extractants may have a pH value in the range of from, for example, 0.1 to 5, preferably 1 to 4.5, and more preferably 2 to 4. The pH value of an extractant may be adjusted by conventional means using a pH adjusting agent such as an carboxylic acid solution, solutions of alkali metal hydroxides, alkali metal hydrogencarbonates or carbonate, and the like.

The extractant may also contain pH adjusting agents, buffers, and like additives other than those mentioned above, provided that the effects of the invention are not adversely affected.

The preparation method for extractants is not restricted, so long as alkali metal carboxylate is contained in the desired concentration. Extractants may be prepared, for example, by dissolving an alkali metal carboxylate in water so that a desired concentration is attained, and adjusting the pH value as necessary.

Further, extractants may be prepared by simply adding an appropriate amount of compound(s) containing alkali metals in the form of hydroxides, hydrogencarbonates and/or carbonates into an aqueous solution of water and carboxylic acid(s) added in a predetermined amount. More specifically, extractants may be prepared by adding aqueous solutions of compounds containing alkali metals in the form of hydroxides, hydrogencarbonates and/or carboxides to aqueous solutions having predetermined concentrations of carboxylic acids (hereinafter referred to as “aqueous solution 1”) so that the aqueous solution 1 has a pH as mentioned above. Specific examples of extractants prepared according to the above process are the aqueous solutions having a carboxylic acid concentration of 0.01 to 2 mol/L, preferably 0.05 to 1 mol/L, and more preferably 0.1 to 0.5 mol/L, and containing alkali metal ions to carboxylic acids in a molar ratio of 0.01-2 to 1, preferably 0.01-1.5 to 1, and more preferably 0.1-1 to 1.

In other words, extractants usable in the detoxification method of the invention are aqueous solutions prepared by a process comprising the following steps (1) and (2): (1) a step of obtaining an aqueous carboxylic acid solution by adding a carboxylic acid to water to have a final carboxylic acid concentration of 0.01 to 2 mol/L, preferably 0.05 to 1 mol/L, and more preferably 0.1 to 0.5 mol/L, and (2) a step of adjusting the pH of the aqueous carboxylic acid solution to be 0.1 to 5, preferably 1 to 4.5, and more preferably 2 to 4, by adding an alkali metal salt in the form of an hydroxide, hydrogencarbonate or carbonate of an alkali metal (prepared, if necessary, as an aqueous solution).

In the present invention, the wood to be detoxified is immersed in such an above extractant and chemical components are removed by extraction therefrom, whereby the wood is detoxified.

According to the invention, a chemical component, i.e., copper, is efficiently removed from the above wood. Further in the invention, when other components such as chromium and arsenic contained in wood preservatives are present in the wood along with copper, they can be removed concurrently with copper.

When extracting the above chemical components from the wood to be detoxified, the wood may be in the form of waste as discarded; however for enhanced extraction efficiency, the wood may be cut to a size having a length, width and thickness of 5 cm, 5 cm and 2 cm or less, respectively.

When extracting the above chemical components from the wood, pressure may be applied or reduced over the wood to be detoxified as necessary while the wood is immersed in the above extractant. By such a step, the extraction efficiency for the above chemical components can be enhanced, whereby the removal of chemical components can be achieved effectively. An extraction method in which immersion of the wood in the above extractant and application or reduction of pressure are repeated exhibits a particularly high efficiency when the wood to be detoxified is relatively large in size or in the form of a square timber. Such treatment involving pressure application or reduction may be carried out using a pressure reducer or an autoclave.

When the above chemical components are extracted and removed by immersing the wood to be detoxified in the extractant, the extraction treatment may be implemented specifically by immersing 1 kg of the wood in 10 to 100 L, and preferably 20 to 50 L, of the extractant.

Further, the extraction temperature for extracting the above chemical components is not limited so long as the temperature does not hinder the extraction of the chemical components. An example of an extraction temperature is within the range of from 15 to 100° C. From the viewpoint of enhancing the extraction efficiency and hence minimizing duration of the extraction, the extraction may be performed at a temperature from 30 to 90° C., and most desirably 50 to 75° C.

Duration of the extraction for extracting the above chemical components varies in accordance with the type of an extractant to be used, variety and size of the wood to be detoxified, extraction method, extraction temperature, expected degree of extraction and so on, and hence cannot be exactly specified. Examples of extraction time are 1 to 10 hours, preferably 3 to 8 hours, and more preferably 4 to 6 hours.

The wood from which the chemical components are thus extracted and removed is detoxified, and can be burned, landfilled or discarded by any other method desired. The detoxified wood can also be recovered for recycling. The extracted chemical components may be subjected to further separation and purification to be utilized effectively as various preservative components.

### EXAMPLES

Examples and Test Examples are given below to illustrate the invention in more detail. However, the present invention is not limited to these examples.

### Example 1

### Detoxification of CCA-Treated Wood

The following evaluation test was performed using CCA-(chromated copper arsenate compound-based wood preservative) treated wood (1 g of dried wood contained 5.10 mg Cu, 4.64 mg As and 8.32 mg Cr).

A sodium hydroxide solution was added to an oxalic acid solution until the mixture had a pH of 3.2 to prepare a sodium oxalate solution (the final concentration of oxalate was 0.125 mol/L). 10 g of the above CCA-treated wood chipped to a size of about 2.5 cm×2.5 cm×1 cm was immersed in 200 ml of the thus prepared aqueous sodium oxalate solution, and extraction was carried out at 75° C. for 6 hours. During the extraction treatment, residual amounts of copper, chromium and arsenic in the wood were determined every hour using an X-ray fluorescence analyzer (JSX-3220 ELEMENT ANALYZER, XRF), and the detoxification degree of the CCA-treated wood was evaluated.

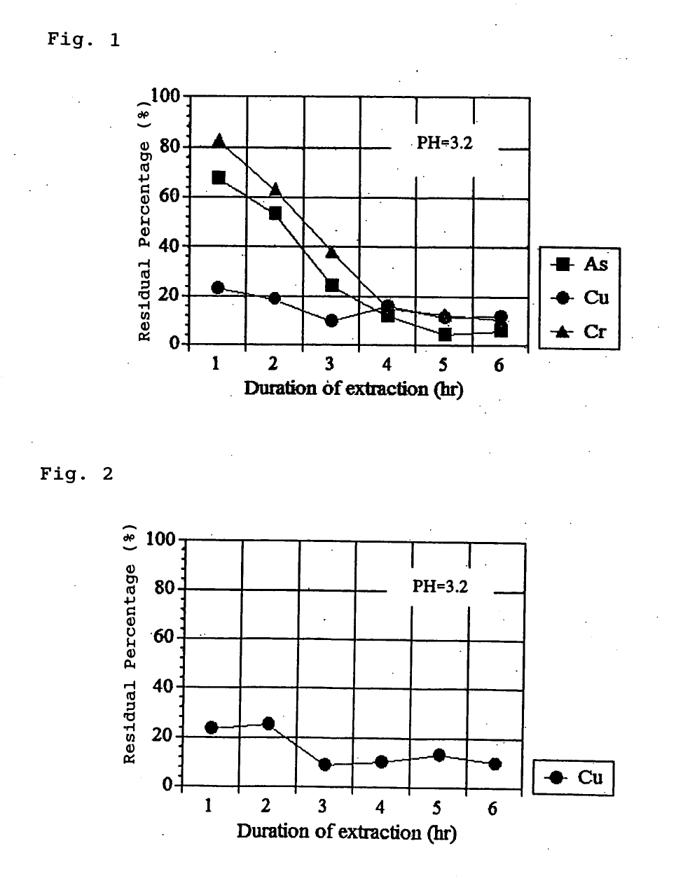

FIG. 1 shows the results obtained. FIG. 1 shows the residual percentages of copper, chromium and arsenic in the wood (calculated based on the level of each metal element in the wood before the extraction treatment being considered as 100%) 1 to 6 hours after the extraction was initiated, using an aqueous sodium oxalate solution (pH 3.2) as an extractant.

As is apparent from FIG. 1, the residual percentages of copper, chromium and arsenic were all confirmed to have been efficiently reduced when an aqueous sodium oxalate solution was used as an extractant. These results indicate that the method of the present invention is confirmed as being capable of efficiently removing copper, chromium and arsenic from CCA-treated wood and thus effectively detoxifying the same.

### Comparative Examples 1 and 2

The following extraction treatment was performed using CCA-treated wood as used in Example 1.

10 g of CCA-treated wood as above chipped to a size of about 2.5 cm×2.5 cm×1 cm was immersed in 200 ml of a 0.125 mol/L oxalic acid solution (pH 1.2), and extraction was carried out at 75° C. for 3 hours (Comparative Example 1).

After the extraction as in Comparative Example 1, the CCA-treated wood was rinsed in water, and further subjected to an extraction treatment in 200 ml of a 0.125 mol/L aqueous sodium hydroxide solution (pH 12.6) at 75° C. for 3 hours (Comparative Example 2).

The detoxification degrees of the CCA-treated wood after extraction treatment (Comparative Examples 1 and 2) were evaluated in the same manner as in Example 1.

The results obtained are shown in Table 1. “Residual Percentage (%)” in Table 1 shows the residual percentages of copper, chromium and arsenic in the wood after the extraction treatment (calculated based on the level of each metal element in the wood before the extraction treatment being considered as 100%). Table 1 also shows the results of Example 1 evaluated 3 hours after the extraction treatment was initiated. The results demonstrate that copper could not be sufficiently removed from CCA-treated wood when an oxalic acid solution was used (Comparative Example 1), or when a sodium hydroxide solution was used after an oxalic acid solution (Comparative Example 2).

TABLE 1

| | Residual Percentage (%) | | |
|---|---|---|---|
| | As | Cu | Cr |
| Example 1 (3 hrs. | 24.3 | 9.5 | 37.7 |
| after extraction) | | | |
| Comparative Ex. 1 | 2.0 | 99.3 | 10.0 |
| Comparative Ex. 2 | 0 | 80.3 | 3.2 |

### Example 2

### Detoxification of ACQ-Treated Wood

The same procedure as in Example 1 was followed to perform a detoxification evaluation test on ACQ (copper alkylammonium compound-based wood preservative)-treated wood, with the exception that ACQ-treated wood (1 g of dried wood containing 2.69 mg of Cu) was used.

The results obtained are shown in FIG. 2. FIG. 2 shows the residual percentage of copper in the wood (calculated based on the copper level in the wood before the extraction treatment being considered as 100%) 1 to 6 hours after the extraction treatment was initiated, using an aqueous sodium oxalate solution (pH 3.2) as an extractant.

As apparent from FIG. 2, when an aqueous sodium oxalate solution was used as an extractant, a low residual percentage of copper in the wood was already indicated after an hour of extraction treatment. This result shows that the method of the present invention is confirmed as being capable of efficiently removing copper from ACQ-treated wood and thus effectively detoxifying the same.

### Example 3

### Detoxification of CUAZ-Treated Wood

The same procedure as in Example 1 was followed to perform a detoxification evaluation test on CUAZ-treated wood, with the exception that CUAZ-(copper boron alkylammonium compound-based wood preservative) treated wood (1 g of dried wood containing 1.63 mg of Cu) was used.

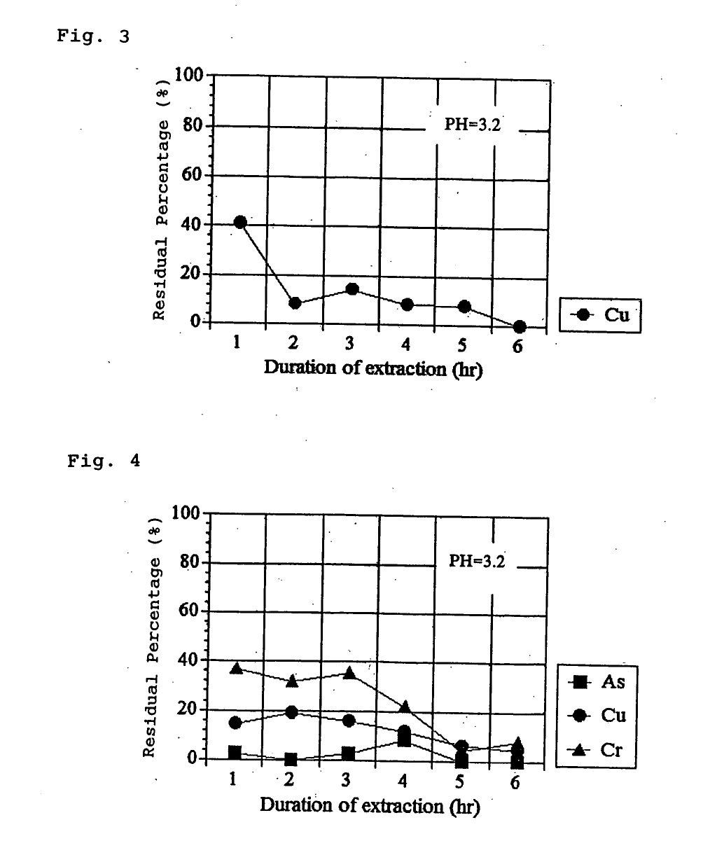

The results obtained are shown in FIG. 3. FIG. 3 shows the residual percentage of copper in the wood (calculated based on the copper level in the wood before the extraction treatment being considered as 100%) 1 to 6 hours after the extraction treatment was initiated, using an aqueous sodium oxalate solution (pH 3.2) as an extractant.

As apparent in FIG. 3, copper is sufficiently removed from the wood when an aqueous sodium oxalate solution was used as an extractant. This result shows that the method of the present invention is confirmed as being capable of efficiently removing copper from CUAZ-treated wood and thus effectively detoxifying the same.

### Example 4

### Detoxification of Mixture of CCA-Treated Wood, ACQ-Treated Wood and CUAZ-Treated Wood

CCA-treated wood as in the above Example 1, ACQ-treated wood as in the above Example 2 and CUAZ-treated wood as in the above Example 3 were collectively subjected to an extraction treatment in a weight ratio of approximately 1:1:1 (1 g of dried wood contained 3.04 mg Cu, 1.6 mg As and 2.96 mg Cr), and a detoxification evaluation test of these woods was performed in the same manner as in Example 1.

The results obtained are shown in FIG. 4. FIG. 4 shows the residual percentage of copper in the wood (calculated based on the copper level in the wood before the extraction treatment being considered as 100%) 1 to 6 hours after the extraction treatment was initiated, using an aqueous sodium oxalate solution (pH 3.2) as an extractant.

The residual percentages of copper, chromium and arsenic were all efficiently reduced when an aqueous sodium oxalate solution was used as an extractant, and these wood were sufficiently detoxified (FIG. 4). These results indicate that the method of the present invention is confirmed as being capable of efficiently extracting and removing hazardous substances such as copper, chromium, arsenic and the like from wood treated with a chemical containing copper, without needing to sort wood by the type of preservative treatment chemicals used, and thus easily and efficiently detoxifying the wood.

### Example 5

A sodium hydroxide solution is added to an acetic acid solution until a pH value of 3.2 is attained to prepare an aqueous sodium acetate solution (the final concentration of acetate was 0.125 mol/L). Copper, chromium and arsenic are extracted from CCA-treated wood in the same manner as in Example 1 using the solution obtained as an extractant, whereby the wood is detoxified.

### Example 6

A sodium hydroxide solution is added to a butandioic acid solution until a pH value of 3.5 is attained to prepare an aqueous sodium butandioate solution (the final concentration of butandioate was 0.125 mol/L). Copper, chromium and arsenic are extracted from CCA-treated wood in the same manner as in Example 1 using the solution obtained as an extractant, whereby the wood is detoxified.

### INDUSTRIAL APPLICABILITY

As clearly demonstrated in the above examples, the extraction and removal of copper from wood, which is not viable using a solution of a monocarboxylic acid and/or dicarboxylic acid, is accomplished with the use of an aqueous solution of alkali metal monocarboxylate and/or alkali metal dicarboxylate as an extractant. Therefore, the method for detoxifying wood of the invention can easily and efficiently extract copper, which is hard to extract by conventional techniques, from wood treated with copper-containing chemicals, whereby the detoxification of wood becomes possible.

Further, as indicated in the above Example 1, the method for detoxifying wood of the invention is able to extract and remove chromium and arsenic in addition to copper, whereby hazardous substances such as copper, chromium and arsenic are collectively extracted and removed from wood containing wood preservative components.

Wood detoxified by the method of the invention can be disposed of by incineration or landfilling, and can be recycled as wood products safe to humans.

1. A method for detoxifying wood comprising immersing, in an aqueous solution of at least one alkali metal carboxylate selected from the group consisting of alkali metal monocarboxylates and alkali metal dicarboxylates, wood treated with a copper-containing chemical, to extract the chemical component from the treated wood.

2. A method for detoxifying wood according to claim 1, wherein the copper-containing chemical further contains at least one component selected from the group consisting of arsenic and chromium.

3. A method for detoxifying wood according to claim 1, wherein the wood treated with a copper-containing chemical has been treated with at least one water-soluble wood preservative selected from the group consisting of CCA, CFKZ, ACQ and CUAZ.

4. A method for detoxifying wood according to claim 1, wherein the carboxylic acid for forming the alkali metal carboxylate is at least one acid selected from the group consisting of formic acid, acetic acid, propionic acid, butyric acid, isobutyric acid, glycolic acid, lactic acid, glyceric acid, oxalic acid, moronic acid, succinic acid, glutaric acid and adipic acid.

5. A method for detoxifying wood according to claim 1, wherein the aqueous alkali metal carboxylate solution has an alkali metal carboxylate concentration of 0.01 to 2 mol/L.

6. A method for detoxifying wood according to claim 1, wherein the aqueous alkali metal carboxylate solution has a pH of 0.1 to 5.

7. A method for detoxifying wood according to claim 1, wherein the aqueous alkali metal carboxylate solution is an aqueous alkali metal dicarboxylate solution.

8. A method for detoxifying wood according to claim 1, wherein the aqueous alkali metal carboxylate solution is an aqueous alkali metal oxalate solution.

9. A method for detoxifying wood according to claim 1, wherein the aqueous alkali metal carboxylate solution is an aqueous sodium oxalate solution.

10. A method for detoxifying wood according to claim 1, wherein the wood is immersed in an aqueous alkali metal carboxylate solution at a temperature of 30 to 90° C.
